(19) United States
(12) Patent Application Publication
(10) Pub. No.: US 2026/0115696 A1
(43) Pub. Date: Apr. 30, 2026

(54) CATALYST FOR AMMONIA DECOMPOSITION AND PREPARATION METHOD THEREFORE

(71) Applicant: University of South Carolina, Columbia, SC (US)

(72) Inventors: Rahat Qazi, Lexington, SC (US); Jochen A. Lauterbach, Columbia, SC (US)

(73) Assignee: University of South Carolina, Columbia, SC (US)

(21) Appl. No.: 19/371,963

(22) Filed: Oct. 28, 2025

Related U.S. Application Data
(60) Provisional application No. 63/713,208, filed on Oct. 29, 2024.

(51) Int. Cl. B01J 23/63; B01J 21/04; B01J 23/10; B01J 35/30; B01J 37/02; B01J 37/03; B01J 37/08; C01B 3/04

(52) U.S. Cl. CPC B01J 23/63; B01J 21/04; B01J 23/10; B01J 35/397; B01J 37/0236; B01J 37/024; B01J 37/031; B01J 37/08; C01B 3/047

(57) ABSTRACT

A catalyst for ammonia decomposition having a support core whose surface is impregnated with a surface oxide wherein the surface oxide impregnated support core is coated with ruthenium. A method for making a catalyst for ammonia decomposition having a support core whose surface is impregnated with a surface oxide wherein the surface oxide impregnated support core is coated with ruthenium.

### CROSS-REFERENCE TO RELATED APPLICATIONS

The present application claims priority to U.S. Provisional Patent Application Ser. No. 63/713,208, filed Oct. 29, 2024, the content of which is incorporated herein in its entirety.

### STATEMENT REGARDING FEDERALLY SPONSORED RESEARCH OR DEVELOPMENT

This invention was made with government support under grant no. N00014-23-1-2724 awarded by the U.S. Office of Naval Research. The government may have certain rights in the invention.

### FIELD OF THE INVENTION

The present invention is directed to an ammonia decomposition catalyst, and more specifically, to a support for an ammonia decomposition catalyst.

### BACKGROUND OF THE INVENTION

Hydrogen is a zero-carbon, high energy-density fuel that holds great promise for replacing fossil fuels in power generation and clean energy applications. Due to the challenges in generating and storing hydrogen for portable applications, ammonia has been proposed as a solution for on-site hydrogen production through ammonia decomposition. Industrial ammonia crackers utilize nickel supported on aluminum oxide as a decomposition catalyst and operate at high temperatures of approximately 850-950° C., requiring high amounts of energy for the process. To reduce the energy requirements, ruthenium-based catalysts can be used. The activity of these catalysts depends on the support materials used for catalyst synthesis.

One exemplary catalyst support is cerium oxide (CeO₂), also known as cerium (IV) oxide, ceric oxide, ceric dioxide, ceria, or cerium dioxide. Cerium oxide is considered to be an efficient support for ruthenium-based catalysts for hydrogen production from ammonia decomposition. However, cerium belongs to the lanthanide group of rare earth metals and is very expensive. This expense makes large-scale industrial application of cerium-supported ruthenium catalysts unsustainable.

Reducing the amount of cerium in these catalysts by introducing alternative compounds impacts the efficacy and properties of these catalysts. For example, reducing the amount of cerium and introducing certain amounts of compounds such as magnesium oxide, silicon dioxide, titanium dioxide, iron oxide, or zirconium dioxide to the catalyst results in a non-functioning catalyst.

### SUMMARY

The present application is for an ammonia decomposition catalyst support composition, comprising a support core, wherein a surface of the support core is impregnated with a surface oxide, and a ruthenium shell coats the support core.

In some embodiments the support core may comprise a metallic or metalloid oxide.

In some embodiments, the metallic or metalloid oxide is selected from the group consisting of: magnesium oxide (MgO), aluminum oxide (Al₂O₃), titanium dioxide (TiO₂), silicon dioxide (SiO₂), zirconium dioxide (ZrO₂), cerium dioxide (CeO₂), lanthanum oxide (La₂O₃), yttrium oxide (Y₂O₃), other metallic or metalloid oxides, and combinations thereof.

In some embodiments, the metallic or metalloid oxide is gamma-alumina.

In some embodiments, a molar ratio of the surface oxide to the metallic or metalloid oxide of the support core ranges from 0.01 to 3.0.

In some embodiments, the surface oxide is a lanthanide oxide. In some embodiments, the lanthanide oxide is a cerium oxide.

In some embodiments, the ruthenium shell is impregnated in the range of 1 to 11 wt %.

The present application is also for a method of manufacturing an ammonia catalyst support composition, comprising the steps of: providing a support core; impregnating a surface of the support core with a surface oxide; and coating the surface oxide with ruthenium. In some embodiments, the surface oxide is a lanthanide oxide. In some embodiments, the lanthanide oxide is cerium oxide.

In some embodiments, the support core is created by: dissolving a core precursor in a solvent and adding to a solution; filtering a solid precipitate from the solution; drying the solid precipitate; comminuting the dried precipitate; and calcining the comminuted precipitate at a given temperature for a period of time. In some embodiments, the precipitate is calcined with a temperature increase rate in the range of 1° C./min to 25° C./min.

In some embodiments, the surface of the support core is impregnated with the surface oxide by adding at least one support core to a solution of a shell precursor to form a deposit mixture; keeping the deposit mixture at a given temperature for a period of time; drying the deposit mixture at a given temperature for a period of time to form impregnated cores; and calcining the impregnated cores at a given temperature for a period of time. In some embodiments, the deposit mixture is kept at a temperature in the range of 18° C. to 80° C. In some embodiments, the deposit mixture is kept at the given temperature for a time in the range of 5 minutes to 3 hours. In some embodiments, the impregnated cores are calcined with a temperature increase rate in the range of 1° C./min to 25° C./min. In some embodiments, the impregnated cores are calcined for a time period ranging from 2 to 8 hours.

In some embodiments, the surface oxide is impregnated with ruthenium by: dissolving a ruthenium precursor in a solvent to form a ruthenium impregnation mixture; adding at least one impregnated core to the ruthenium impregnation mixture to form the ammonia decomposition catalyst; and calcining the ammonia decomposition catalyst at a given temperature for a period of time. In some embodiments, the ruthenium precursor is selected from the group including ruthenium carbonyl (Ru(CO₃)₁₂), ruthenium chloride (RuCl₃), ruthenium acetylacetonate (Ru(O₂C₅H₇)₃), ruthenium (III) nitrosyl nitrate (Ru(NO)(NO₃)₃), ruthenium (III)-DPM (C₃₃H₅₇O₆Ru), Ru(OH)(NO)(NH₃)₄)(NO₃)₂, ruthenium nitrate (Ru(NO₃)₃), hexaammine ruthenium (III) chloride (Ru(NH₃)₆C₁₃), and sodium ruthenate (Na₂O₄Ru).

### BRIEF DESCRIPTION OF THE SEVERAL VIEWS OF THE DRAWINGS

FIG. 1 is a cross-sectional view of a catalyst structure in embodiments.

FIG. 2 is a cross-sectional view of a catalyst structure in embodiments.

FIGS. 3A through 3B are a flowchart of a method for manufacturing the catalyst structure in embodiments.

FIGS. 4A through 4B are a flowchart of a method for manufacturing the catalyst structure in embodiments.

FIG. 5 is a chart illustrating the ammonia decomposition efficiency as a function of temperature for pure gamma-alumina, various molar ratios of cerium and aluminum in cerium oxide impregnated gamma-alumina, and pure cerium oxide as support for ruthenium catalysts.

FIG. 6 is a chart illustrating X-ray diffraction patterns for catalyst structures variously comprising pure gamma-alumina, various molar ratios of cerium and aluminum in cerium oxide impregnated gamma-alumina, and pure cerium oxide.

### DETAILED DESCRIPTION OF THE INVENTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Dimensions and materials identified in the drawings and applications are by way of example only and are not intended to limit the scope of the claimed invention. Any other dimensions and materials not consistent with the purpose of the present application can also be used. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

There is a need for an ammonia decomposition catalyst capable of decomposing large amounts of ammonia and producing large amounts of hydrogen while using lesser amounts of catalyst supports like cerium. Disclosed herein are ammonia decomposition catalyst structures and methods of preparing the same that use lesser amounts of expensive catalyst supports like cerium by introducing less expensive compounds thus allowing for large-scale industrial decomposition of ammonia.

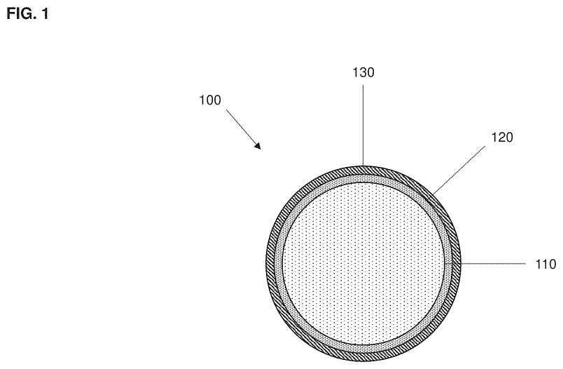

FIG. 1 depicts an embodiment of an ammonia decomposition catalyst structure 100. As shown in FIG. 1, in embodiments, the catalyst structure 100 is a core-shell type support impregnated with a ruthenium catalyst. The core 110 is a metallic or metalloid oxide, which is then impregnated on its surface with a surface oxide 120. In some embodiments, the metallic or metalloid core oxide may be selected from the group including aluminum oxide (Al₂O₃), magnesium oxide (MgO), titanium dioxide (TiO₂), silicon dioxide (SiO₂), zirconium dioxide (ZrO₂), lanthanum oxide (La₂O₃), yttrium oxide (Y₂O₃), other metallic or metalloid oxides, and combinations thereof. In one embodiment, the core oxide is gamma-alumina (γ-Al₂O₃). In some embodiments, the surface oxide 120 is a lanthanide oxide. In some embodiments, the surface oxide 120 is cerium oxide. In some embodiments, the molar ratio of the surface oxide 120 to the metallic or metalloid oxide of the core 110 is selected from the range of approximately 0.01 to 3.0. While the present embodiment shows a spherical configuration of the catalyst structure 100, it should be understood that any regularly- or irregularly-shaped configuration or combination of configurations of the catalyst structure 100 is contemplated.

In some embodiments, the prepared surface oxide/core oxide supports (i.e., the impregnated core) are impregnated with a shell of ruthenium 130 to form the catalyst structure 100. In some embodiments, the shell of ruthenium 130 may instead be a shell of noble and non-noble metals such as Nickel (Ni), Manganese (Mn), Iron (Fe), Cobalt (Co), Copper (Cu), and Molybdenum (Mo). In some embodiments, high entropy alloy nanoparticles such as (Ru, Pt, Pd, Co, Ni), (Co, Mo, Pt, Pd, Ni), (Co, Mo, Pt, Fe, Ni), (Mn, Fe, Co, Ni, Cu), and (Mo, Ru, Rh, Pt, Pd) may be loaded onto the prepared surface oxide/core oxide supports. The constituent elements of the high entropy alloy nanoparticles exist in roughly equal molar proportions. For example, (Ru, Pt, Pd, Co, Ni) comprises approximately 20 mole-% Ru, approximately 20 mole-% Pt, approximately 20 mole-% Pd, approximately 20 mole-% Co, and approximately 20 mole-% Ni. In some embodiments, the ruthenium 130 may be impregnated at a level between 1 and 11 wt %. The presence of metallic or metalloid oxide in bulk as the core 110 and the loading of the surface oxide 120 only on the surface of the core 110 decreases the overall cost of the catalysts.

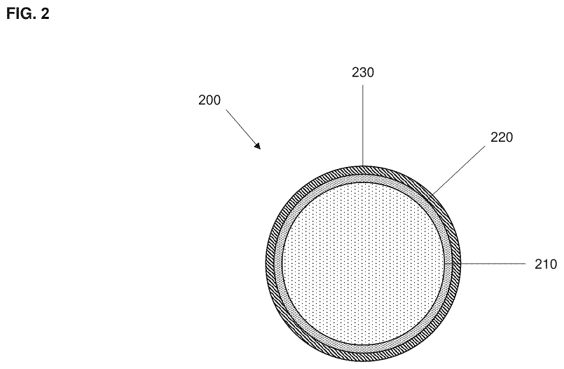

FIG. 2, shows an alternative embodiment of a catalyst structure 200. In some embodiments, the core 210 is a lanthanide oxide which is then impregnated on its surface with a surface oxide 220. In some embodiments the lanthanide oxide 210 is cerium oxide. In some embodiments, the surface oxide 220 is a metallic or metalloid oxide. In some embodiments, the molar ratio of the lanthanide oxide 210 to the metallic or metalloid oxide 220 is selected from the range of 0.01 to 3.0. The metallic or metalloid oxide 220 may be selected from the group including aluminum oxide (Al₂O₃), magnesium oxide (MgO), titanium dioxide (TiO₂), silicon dioxide (SiO₂), zirconium dioxide (ZrO₂), lanthanum oxide (La₂O₃), yttrium oxide (Y₂O₃), other metallic or metalloid oxides, and combinations thereof. While the present embodiment shows a spherical configuration of the catalyst structure 200, it should be understood that any regularly- or irregularly-shaped configuration or combination of configurations of the catalyst structure 200 is contemplated.

In some embodiments, the prepared metallic or metalloid oxide/lanthanide oxide supports (i.e., the impregnated core) are impregnated with a shell of ruthenium 230 to form the catalyst structure 200. In some embodiments, the shell of ruthenium 230 may instead be a shell of noble and non-noble metals such as Nickel (Ni), Manganese (Mn), Iron (Fe), Cobalt (Co), Copper (Cu), and Molybdenum (Mo). In some embodiments, high entropy alloy nanoparticles such as (Ru, Pt, Pd, Co, Ni), (Co, Mo, Pt, Pd, Ni), (Co, Mo, Pt, Fe, Ni), (Mn, Fe, Co, Ni, Cu), and (Mo, Ru, Rh, Pt, Pd) may be loaded onto the prepared metallic or metalloid oxide/lanthanide oxide supports. The constituent elements of the high entropy alloy nanoparticles exist in roughly equal molar proportions. For example, (Ru, Pt, Pd, Co, Ni) comprises approximately 20 mole-% Ru, approximately 20 mole-% Pt, approximately 20 mole-% Pd, approximately 20 mole-% Co, and approximately 20 mole-% Ni. In some embodiments, the ruthenium 230 may be impregnated at a level between 1 and 11 wt %.

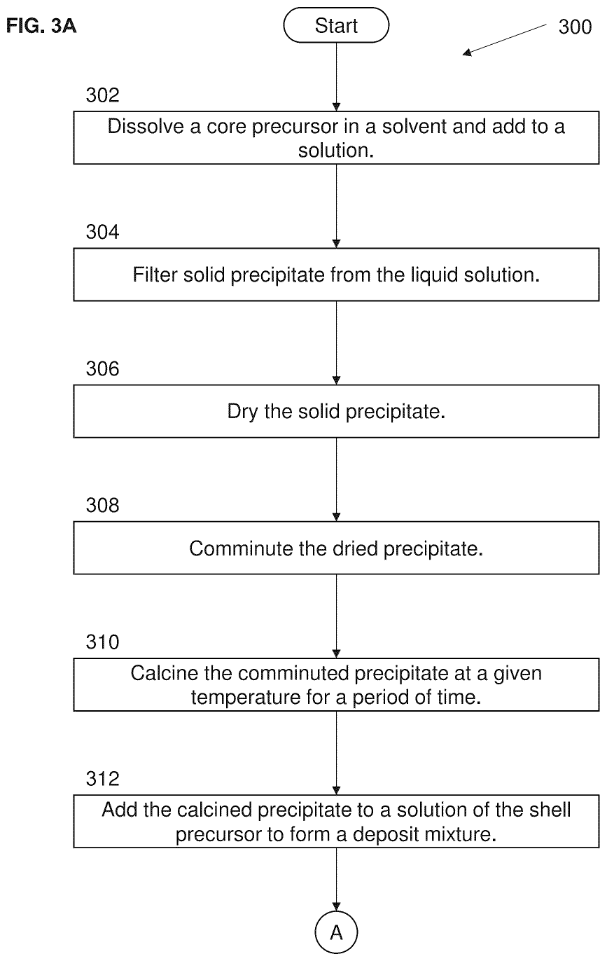

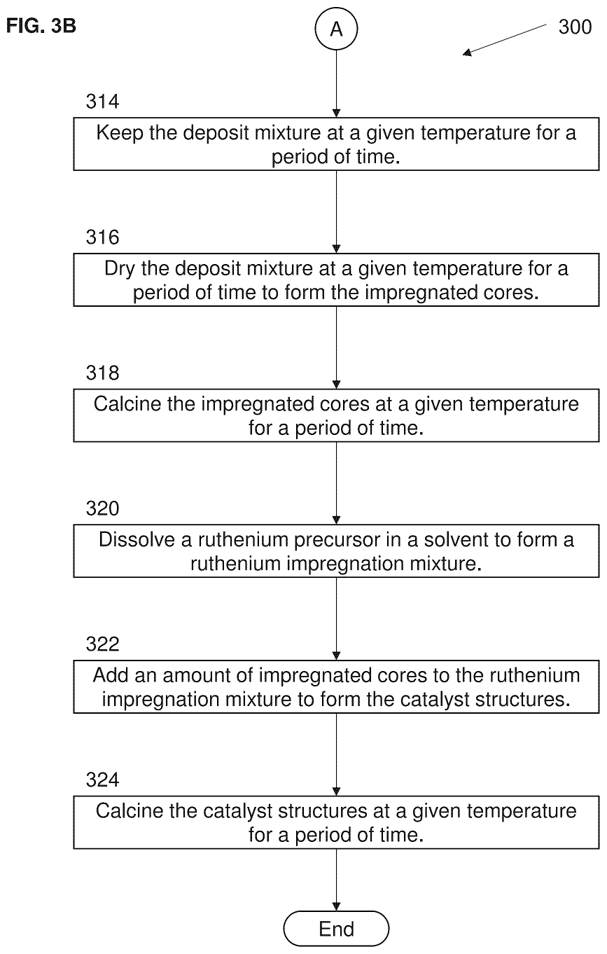

FIG. 3A through 3B illustrate some embodiments of a method 300 for preparation of the catalyst structure 100. In the first subset of the method in blocks 302 to 310, the core 110 is formed. In the second subset of the method in blocks 312 to 318, the surface oxide 120 is coated on the core 110. In the third subset of the method in blocks 320 to 324, the ruthenium 130 is formed on the surface oxide 120. In certain embodiments, the surface oxide 120 may be deposited on the core 110.

In some embodiments, the precipitation/deposition method of blocks 302 to 310 may be replaced by another method including, but not limited to, the sol-gel method, thermal decomposition, and hydrothermal method. In some embodiments, the surface oxide impregnation method of blocks 312 to 318 may be replaced by another method including, but not limited to, the sol-gel method, chemical vapor deposition (CVD), and pulse layer deposition (PLD). In some embodiments, the ruthenium impregnation method of blocks 320 to 324 may be replaced by another method including, but not limited to, co-precipitation/co-deposition, the sol-gel method, CVD, and PLD.

In block 302, a core precursor is dissolved in a solvent and added to a solution. In some embodiments, the core precursor is a metallic or metalloid precursor. In some embodiments, the core precursor is an aluminum nitrate nonahydrate (Al(NO₃)₃·9H₂O) precursor. In some embodiments, the core precursor is an aluminum sulfate (Al₂(SO₄)₃) precursor. In some embodiments, the core precursor is an aluminum chloride (AlCl₃) precursor. In some embodiments, the core precursor is an aluminum acetate (Al(C₂H₃O₂)₃) precursor. In some embodiments, the solvent is water. In some embodiments, the solvent is distilled water. In some embodiments, the solvent is deionized water. In some embodiments, the solvent is double deionized water. In some embodiments, the solvent is tap water. In some embodiments, the solution is a solution of ammonium hydroxide. In some embodiments, the solution is a solution of ammonia. In some embodiments, the solution is a solution of ammonium carbonate. In some embodiments, the solution is a solution of ammonium bicarbonate. In some embodiments, the solution is a solution of sodium hydroxide. In some embodiments, the dissolved core precursor is added dropwise. In some embodiments, the solution is added dropwise to the core precursor that is dissolved in a solvent. In some embodiments, ammonium hydroxide is added dropwise to the core precursor that is dissolved in a solvent. In some embodiments, the dissolved core precursor is added under constant stirring.

In block 304, solid precipitate is filtered from the liquid solution.

In block 306, the solid precipitate is dried. In some embodiments, the precipitate is dried at a temperature ranging from approximately 21° C. to 120° C.

In block 308, the dried precipitate is comminuted. In some embodiments, the precipitate is crushed. In some embodiments, the precipitate is crushed by a mortar and pestle.

In block 310, the comminuted precipitate is calcined at a given temperature for a period of time. In some embodiments, the precipitate is calcined in air. In some embodiments, the precipitate is calcined at a temperature between 35° and 1200° C. In some embodiment, the precipitate is calcined for a time period ranging from 2 to 8 hours. In some embodiments, the precipitate is calcined with a temperature increase rate in the range of 1° C./min to 25° C./min.

In block 312, the calcined precipitate is added to a solution of the shell precursor to form a deposit mixture. In some embodiments, the shell precursor is cerium nitrate hexahydrate (Ce(NO₃)₃·6H₂O). In some embodiments, the shell precursor is cerium(III) chloride (CeCl₃). In some embodiments, the shell precursor is ceric ammonium nitrate ((NH₄)₂[Ce(NO₃)₆]). In some embodiments, the solution of the shell precursor includes water. In some embodiments, the solution of the shell precursor includes distilled water. In some embodiments, the solution of the shell precursor includes deionized water. In some embodiments, the solution of the shell precursor includes double deionized water. In some embodiments, the solution of the shell precursor includes tap water.

In block 314, the deposit mixture is kept at a given temperature for a period of time. In some embodiments, the deposit mixture is kept at a temperature between 18° C. and 80° C. In some embodiments, the deposit mixture is kept at the given temperature for a time between 5 minutes and 3 hours.

In block 316, the deposit mixture is dried at a given temperature for a period of time to form the impregnated cores. In some embodiments, the deposit mixture is dried at a temperature between 100° C. and 220° C. In some embodiments, the deposit mixture is dried for a time between 2 hours and 24 hours. In some embodiments, the deposit mixture is dried in an oven.

In block 318, the impregnated cores are calcined at a given temperature for a period of time. In some embodiments, the impregnated cores are calcined in air. In some embodiments, the impregnated cores are calcined at a temperature ranging from approximately 300° C. to approximately 900° C. In some embodiments, the impregnated cores are calcined at a given temperature of 600° C. In some embodiments, the impregnated cores are calcined for a time period ranging from 2 to 8 hours. In some embodiments, the impregnated cores are calcined with a temperature increase rate between 1° C./min and 25° C./min.

In block 320, a ruthenium precursor is dissolved in a solvent to form a ruthenium impregnation mixture. In some embodiments, the ruthenium precursor is selected from the group including ruthenium carbonyl (Ru(CO₃)₁₂), ruthenium chloride (RuCl₃), ruthenium acetylacetonate (Ru(O₂C₅H₇)₃), ruthenium (III) nitrosyl nitrate (Ru(NO)(NO₃)₃), ruthenium (III)-DPM (C₃₃H₅₇O₆Ru), Ru(OH)(NO)(NH₃)₄)(NO₃)₂, ruthenium nitrate (Ru(NO₃)₃), hexaammine ruthenium (III) chloride (Ru(NH₃)₆Cl₃), and sodium ruthenate (Na₂O₄Ru). In some embodiments, the solvent is selected from a group including tetrahydrofuran (THF), deionized water, acetone, ethanol, methanol, n-propanol, isopropanol, butanol, pentanol, n-hexane, toluene, and combinations thereof.

In block 322, at least one impregnated core is added to the ruthenium impregnation mixture to form the catalyst structures 100.

In block 324, the catalyst structures 100 are calcined at a given temperature for a period of time. In some embodiments, the catalyst structures 100 are calcined under a gas flow, with the gas selected from the group including argon, nitrogen, helium, hydrogen, and air. In some embodiments, the impregnated cores are calcined at a temperature ranging from approximately 300° C. to 550° C. In some embodiments, the impregnated cores are calcined for a period of time ranging from approximately 1 hour to 5 hours.

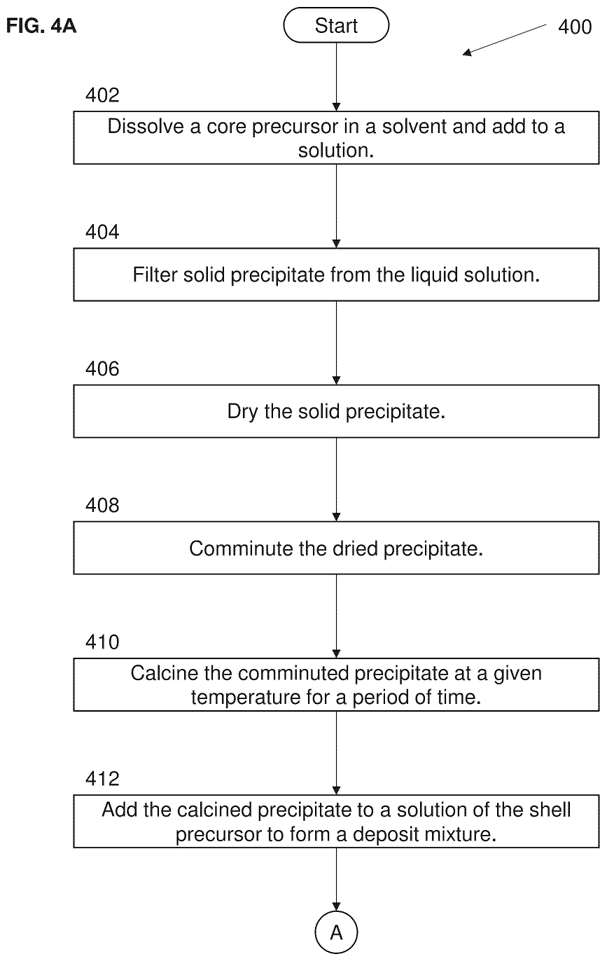

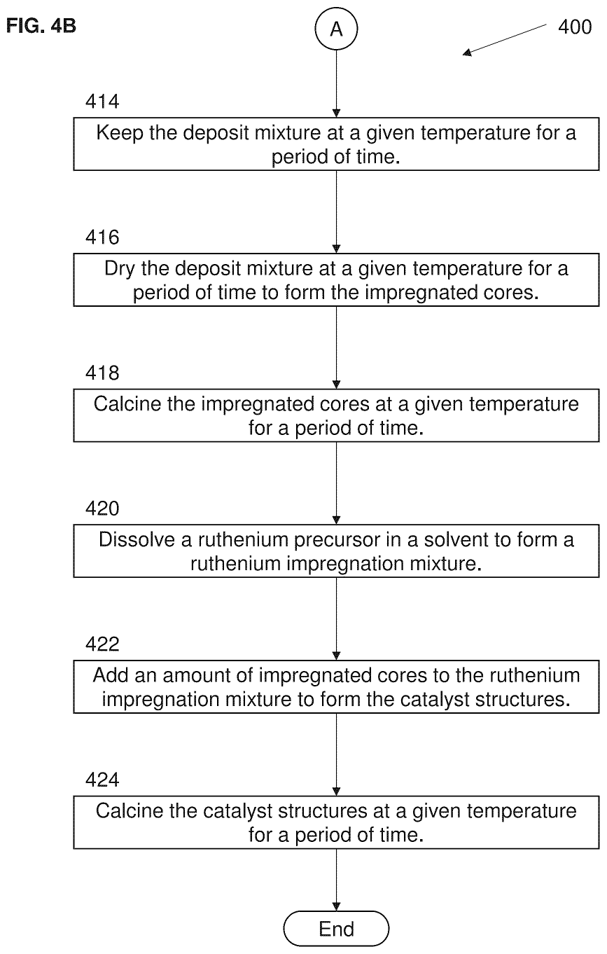

FIG. 4A through 4B illustrate some embodiments of a method 400 for preparation of the catalyst structure 200. In the first subset of the method in blocks 402 to 410, the core 210 is formed. In the second subset of the method in blocks 412 to 418, the metallic or metalloid oxide 220 is coated on the core 210. In the third subset of the method in blocks 420 to 424, the ruthenium 230 is formed on the metallic or metalloid oxide 220.

In some embodiments, the ruthenium impregnation method of blocks 420 to 424 may be replaced by another method including, but not limited to, co-precipitation/co-deposition, the sol-gel method, CVD, and PLD.

In block 402, a core precursor is dissolved in a solvent and added to a solution. In some embodiments, the core precursor is cerium nitrate hexahydrate (Ce(NO₃)₃·6H₂O). In some embodiments, the core precursor is cerium(III) chloride (CeCl₃). In some embodiments, the core precursor is ceric ammonium nitrate ((NH₄)₂[Ce(NO₃)₆]). In some embodiments, the solvent is water. In some embodiments, the solvent is distilled water. In some embodiments, the solvent is deionized water. In some embodiments, the solvent is double deionized water. In some embodiments, the solvent is tap water. In some embodiments, the solution is a solution of ammonium hydroxide. In some embodiments, the solution is a solution of ammonia. In some embodiments, the solution is a solution of ammonium carbonate. In some embodiments, the solution is a solution of ammonium bicarbonate. In some embodiments, the solution is a solution of sodium hydroxide. In some embodiments, the dissolved core precursor is added dropwise. In some embodiments, the solution is added dropwise to the core precursor that is dissolved in a solvent. In some embodiments, ammonium hydroxide is added dropwise to the core precursor that is dissolved in a solvent. In some embodiments, the dissolved core precursor is added under constant stirring.

In block 404, solid precipitate is filtered from the liquid solution.

In block 406, the solid precipitate is dried. In some embodiments, the precipitate is dried at a temperature ranging from approximately 21° C. to 120° C.

In block 408, the dried precipitate is comminuted. In some embodiments, the precipitate is crushed. In some embodiments, the precipitate is crushed by a mortar and pestle.

In block 410, the comminuted precipitate is calcined at a given temperature for a period of time. In some embodiments, the precipitate is calcined in air. In some embodiments, the precipitate is calcined at a temperature between 30° and 900° C. In some embodiment, the precipitate is calcined for a time period ranging from 2 to 8 hours. In some embodiments, the precipitate is calcined with a temperature increase rate in the range of 1° C./min to 25° C./min.

In block 412, the calcined precipitate is added to a solution of the shell precursor to form a deposit mixture. In some embodiments, the shell precursor is a metallic or metalloid precursor. In some embodiments, the shell precursor is an aluminum nitrate nonahydrate (Al(NO₃)₃·9H₂O) precursor. In some embodiments, the shell precursor is an aluminum sulfate (Al₂(SO₄)₃) precursor. In some embodiments, the shell precursor is an aluminum chloride (AlCl₃) precursor. In some embodiments, the shell precursor is an aluminum acetate (Al(C₂H₃O₂)₃) precursor. In some embodiments, the solution of the shell precursor includes water. In some embodiments, the solution of the shell precursor includes distilled water. In some embodiments, the solution of the shell precursor includes deionized water. In some embodiments, the solution of the shell precursor includes double deionized water. In some embodiments, the solution of the shell precursor includes tap water.

In block 414, the deposit mixture is kept at a given temperature for a period of time. In some embodiments, the deposit mixture is kept at a temperature between 18° C. and 80° C. In some embodiments, the deposit mixture is kept at the given temperature for a time between 5 minutes and 3 hours.

In block 416, the deposit mixture is dried at a given temperature for a period of time to form the impregnated cores. In some embodiments, the deposit mixture is dried at a temperature between 100° C. and 220° C. In some embodiments, the deposit mixture is dried for a time between 2 hours and 24 hours. In some embodiments, the deposit mixture is dried in an oven.

In block 418, the impregnated cores are calcined at a given temperature for a period of time. In some embodiments, the impregnated cores are calcined in air. In some embodiments, the impregnated cores are calcined at a temperature ranging from approximately 350° C. to approximately 1200° C. In some embodiments, the impregnated cores are calcined at a given temperature of 600° C. In some embodiments, the impregnated cores are calcined for a time period ranging from 2 to 8 hours. In some embodiments, the impregnated cores are calcined with a temperature increase rate between 1° C./min and 25° C./min.

In block 420, a ruthenium precursor is dissolved in a solvent to form a ruthenium impregnation mixture. In some embodiments, the ruthenium precursor is selected from the group including ruthenium carbonyl (Ru(CO₃)₁₂), ruthenium chloride (RuCl₃), ruthenium acetylacetonate (Ru(O₂C₅H₇)₃), ruthenium (III) nitrosyl nitrate (Ru(NO)(NO₃)₃), ruthenium (III)-DPM (C₃₃H₅₇O₆Ru), Ru(OH)(NO)(NH₃)₄)(NO₃)₂, ruthenium nitrate (Ru(NO₃)₃), hexaammine ruthenium (III) chloride (Ru(NH₃)₆Cl₃), and sodium ruthenate (Na₂O₄Ru). In some embodiments, the solvent is selected from a group including tetrahydrofuran (THF), deionized water, acetone, ethanol, methanol, n-propanol, isopropanol, butanol, pentanol, n-hexane, toluene, and combinations thereof.

In block 422, at least one impregnated core is added to the ruthenium impregnation mixture to form the catalyst structures 200.

In block 424, the catalyst structures 200 are calcined at a given temperature for a period of time. In some embodiments, the catalyst structures 200 are calcined under a gas flow, with the gas selected from the group including argon, nitrogen, helium, hydrogen, and air. In some embodiments, the impregnated cores are calcined at a temperature ranging from approximately 300° C. to 550° C. In some embodiments, the impregnated cores are calcined for a period of time ranging from approximately 1 hour to 5 hours.

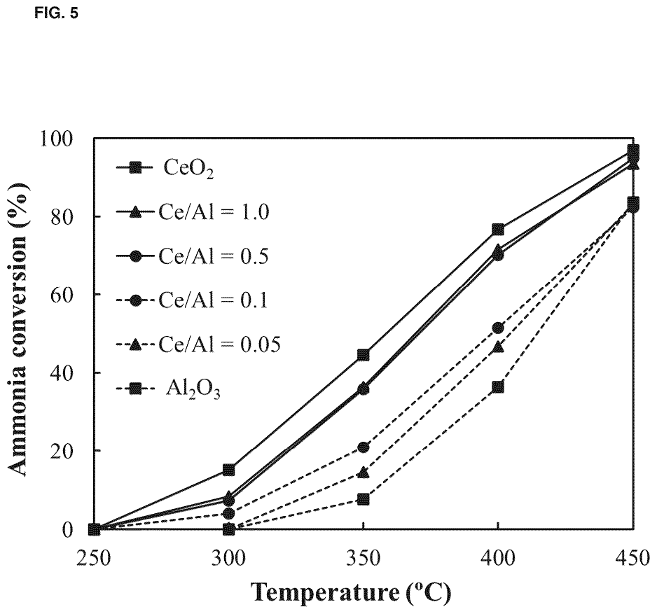

FIG. 5 is a chart illustrating the ammonia decomposition efficiency as a function of temperature for pure gamma-alumina, various molar ratios of cerium oxide and gamma-alumina, and pure cerium oxide as support for ruthenium catalysts. The ammonia decomposition efficiency was evaluated at 250° C., 300° C., 350° C., 400° C., and 450° C. temperatures. As can be seen from FIG. 5, the ammonia decomposition efficiency of cerium oxide and gamma-alumina supported ruthenium catalysts with a cerium to aluminum molar ratio of 0.5 and above was comparable to ruthenium catalysts supported with pure cerium oxide. The presence of low-cost gamma-alumina in larger amounts decreases the overall cost of the catalyst. Hence, cerium oxide and gamma-alumina-supported ruthenium catalysts are suggested as efficient and cost-effective catalysts for ammonia decomposition.

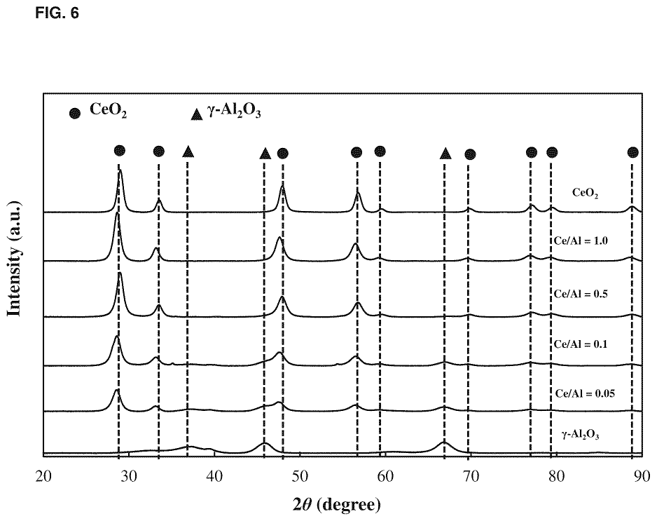

FIG. 6 is a chart illustrating X-ray diffraction (XRD) patterns for catalyst structures 100 variously comprising pure gamma-alumina, various molar ratios of cerium and aluminum in cerium oxide impregnated gamma-alumina, and pure cerium oxide. Impregnation of cerium oxide on the surface of gamma-alumina showed peaks for both cerium oxide and gamma-alumina. With an increase in cerium oxide loading resulting in a cerium to aluminum molar ratio of 0.1, fading of peaks for gamma-alumina were noticed. As the amount of cerium oxide loading increased to molar ratios of 0.5 and 1.0, only cerium oxide peaks can be seen in the XRD pattern. This indicates that the surface of cerium oxide/gamma-alumina-supported ruthenium catalysts with cerium to aluminum molar ratios of 0.5 and 1.0 were comparable to the pure cerium oxide supported ruthenium catalyst. Hence, it can be suggested that the surface of gamma-alumina was homogeneously coated with cerium oxide on cerium oxide/gamma-alumina-supported ruthenium catalysts with cerium to aluminum molar ratios of at least 0.5 and 1.0, and that molar ratios of above 0.1 but below 0.5 may also have homogeneous coating.

It is to be understood that this written description uses examples to disclose the invention, including the best mode, and also to enable any person skilled in the art to make anew the invention. The various embodiments of the invention may be combined in any arrangement capable of manufacturing an ammonia decomposition catalyst support. Any dimensions or other size descriptions are provided for purposes of illustration and are not intended to limit the scope of the claimed invention. Additional embodiments can include variations in composition and methods of component synthesis and combination, as well as variations required for use in the industry. The patentable scope of the invention may include other examples that occur to those skilled in the art.

It is to be understood that the following claims are exemplary in nature only, and do not and should not be interpreted to place any limitations on any claims in any subsequent applications whatsoever.

What is claimed is:

1. An ammonia decomposition catalyst support composition, comprising:
a support core, wherein a surface of the support core is impregnated with a surface oxide; and
a ruthenium shell coating the surface oxide impregnated support core.

2. The composition of claim 1, wherein the support core comprises a metallic or metalloid oxide.

3. The composition of claim 2, wherein the metallic or metalloid oxide is selected from the group consisting of: magnesium oxide (MgO), aluminum oxide (Al₂O₃), titanium dioxide (TiO₂), silicon dioxide (SiO₂), zirconium dioxide (ZrO₂), cerium dioxide (CeO₂), lanthanum oxide (La₂O₃), yttrium oxide (Y₂O₃), other metallic or metalloid oxides, and combinations thereof.

4. The composition of claim 2, wherein the metallic or metalloid oxide is gamma-alumina.

5. The composition of claim 2, wherein a molar ratio of the surface oxide to the metallic or metalloid oxide of the support core ranges from 0.01 to 3.0.

6. The composition of claim 1, wherein the surface oxide is a lanthanide oxide.

7. The composition of claim 6, wherein the lanthanide oxide is a cerium oxide.

8. The composition of claim 1, wherein the ruthenium is impregnated in the range of 1 toll wt %.

9. A method of manufacturing an ammonia catalyst support composition, comprising:
providing a support core;
impregnating a surface of the support core with a surface oxide; and
coating the surface oxide with ruthenium.

10. The method of claim 9, wherein the support core is created by:
dissolving a core precursor in a solvent and adding to a solution;
filtering a solid precipitate from the solution;
drying the solid precipitate;
comminuting the dried precipitate; and
calcining the comminuted precipitate at a given temperature for a period of time.

11. The method of claim 9, wherein the surface of the support core is impregnated with the surface oxide by:
adding at least one support core to a solution of a shell precursor to form a deposit mixture;
keeping the deposit mixture at a given temperature for a period of time;
drying the deposit mixture at a given temperature for a period of time to form impregnated cores; and
calcining the impregnated cores at a given temperature for a period of time.

12. The method of claim 9, wherein, the surface oxide is impregnated with ruthenium by:
dissolving a ruthenium precursor in a solvent to form a ruthenium impregnation mixture;
adding at least one impregnated core to the ruthenium impregnation mixture to form the ammonia decomposition catalyst support composition; and
calcining the ammonia decomposition catalyst support composition at a given temperature for a period of time.

13. The method of claim 9, wherein the surface oxide is a lanthanide oxide.

14. The method of claim 13, wherein the lanthanide oxide is cerium oxide.

15. The method of claim 10, wherein the precipitate is calcined with a temperature increase rate in the range of 1° C./min to 25° C./min.

16. The method of claim 11, wherein the deposit mixture is kept at a temperature in the range of 18° C. to 80° C.

17. The method of claim 11, wherein the deposit mixture is kept at the given temperature for a time in the range of 5 minutes to 3 hours.

18. The method of claim 11, wherein the impregnated cores are calcined with a temperature increase rate in the range of 1° C./min to 25° C./min.

19. The method of claim 11, wherein the impregnated cores are calcined for a time period ranging from 2 to 8 hours.

20. The method of claim 12, wherein the ruthenium precursor is selected from the group including ruthenium carbonyl (Ru(CO₃)₁₂), ruthenium chloride (RuCl₃), ruthenium acetylacetonate (Ru(O₂C₅H₇)₃), ruthenium (III) nitrosyl nitrate (Ru(NO)(NO₃)₃), ruthenium (III)-DPM (C₃₃H₅₇O₆Ru), Ru(OH)(NO)(NH₃)₄)(NO₃)₂, ruthenium nitrate (Ru(NO₃)₃), hexaammine ruthenium (III) chloride (Ru(NH₃)₆Cl₃), and sodium ruthenate (Na₂O₄Ru).
